(19) United States
(12) Patent Application Publication
(10) Pub. No.: US 2009/0133467 A1
(43) Pub. Date: May 28, 2009

(54) Robot Equipped with a Gyro and Gyro Calibration Apparatus, Program, and Method

(75) Inventors: Takemitsu Mori, Aichi-ken (JP); Takashi Kato, Aichi-ken (JP); Yutaka Nonomura, Aichi-ken (JP); Motohiro Fujiyoshi, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: TOYOTA JIDOSHA KABUSHIKI KAISHA, Toyota-shi (JP); KABUSHIKI KAISHA TOYOTA CHUO KENKYUSHO, Aichi-gun (JP)

(21) Appl. No.: 11/989,691

(22) PCT Filed: Aug. 1, 2006
(86) PCT No.: PCT/IB2006/002103

§ 371 Date: Jan. 30, 2008

(30) Foreign Application Priority Data
Aug. 1, 2005 (JP) 2005-223503

(51) Int. Cl. G01C 25/00

(52) U.S. Cl. 73/1.77; 700/258

(57) ABSTRACT

While calibrating the position of a robot having a gyro, the robot emits a beam of light to a target wall surface, and the position of a laser point on the target wall surface illuminated by the beam of light is measured. The measured position is obtained as an initial value (S10, S12), and a start of calibration is indicated (S14, S16). Then, a calibration period is reset (S18) and the timekeeping process of the calibration period starts. The values detected by the gyro are consecutively obtained by sampling for a predetermined calibration period (S20). If a disturbance occurs while the values are obtained, an alarm is output and calibration restarts. Once the calibration period elapses without any disturbance, a calibrated value is set or determined based on the detected values obtained during the calibration period (S26, S28).

### BACKGROUND OF THE INVENTION

1. Field of the Invention

This invention relates to, a robot equipped with a gyro and a gyro calibration apparatus, program, and method. In particular, this invention relates to the calculation of positional information in a robot that equipped with a gyro based on values detected by the gyro, a gyro calibration apparatus and a method that calibrates the gyro, and a gyro calibration program.

2. Description of the Related Art

Mobile robots, such as bipedal robots (robot walking with two legs) or mobile robots for the purpose of entertainment, are known. To move to a target position, such robots detect or calculate changes in the position of the robot over time. Generally, such technology is known as a position-detecting method of a mobile object, and various approaches may be taken to improve the precision/accuracy of the position detection.

For example, JP-A-07-286858 describes an obstacle detection apparatus installed on a vehicle that attempts to improve the precision/accuracy in detecting the location of the vehicle by the vehicle navigation apparatus. The obstacle detection apparatus reads the absolute location data on a location displaying board provided on the side of the road, and the vehicle navigation apparatus performs a calibration in determining the location of the vehicle using the read data. An example of the obstacle detection apparatus uses two CCDs, which are separated by a predetermined distance in a direction perpendicular to the optical axis, and detects the distance to the obstacle by using the change in parallax. Another example of the obstacle detection apparatus uses a single CCD and a location data display unit on which patterns are displayed by a light emitter. The location data display unit displays base-line length data indicating a physical length of the light emitter, in addition to the pattern indicating a location data signal. The distance to the location data display unit is calculated based on the base-line length. Accordingly, the accuracy of location by the navigation apparatus using a GPS method is improved from several dozen meters to below several meters.

However, it is difficult for the short-travel-purpose mobile robot to use the GPS method and its calibration method described in JP-A-07-286858. In the meantime, a mobile robot may have a function of “eyes,” such as a position detection camera. In such a case, the present location, etc. of the robot may be detected or calculated from the image captured by the position detection camera. Generally, however, the technology of the position detection camera and image recognition is relatively expensive and requires sufficient lighting.

Accordingly, a gyro, such as a three-dimensional optical gyro may be mounted on the robot. Changes over time in the directions of three axes are detected, and any detected change, such as an angular speed, is converted into the location information by calculation.

In the calibration of the gyro in this case, the position and orientation of the robot may be fixed by positioning jig set on the floor. Then, the sensitivity of the gyro is measured using a big turntable that rotates the gyro mounted on the robot. Accordingly, because the calibration is performed whenever the robot is moved to a different working location, the delivery of the large jig, setting of the robots on the jig, and measuring of orientations and positions are required. Thus, this technology is laborious and inconvenient.

While the gyro used for this purpose provides a high accuracy, it is easily influenced by or interfered with mechanical disturbances or noises caused by, for example, the precession of the earth axis. Thus, a generally used gyro is also largely influenced by or interfered with noises when calibrating the point of origin, which is a reference of angle speed in the directions of three axes. A calibration over a short time is influenced by accidental noises, while a calibration over a long time almost always includes noise components. Since the calibration method according to JP-A-07-286858 detects and uses an external reference location, such a calibration method is not appropriate to use for a gyro that is largely influenced by noises.

As described above, the calibration of gyro mounted on the robot is largely influenced by external noises, and the setting thereof, including the measuring of the position and orientation, is complicated.

### SUMMARY OF THE INVENTION

The present invention provides a robot equipped with a gyro, a gyro calibration apparatus, a gyro calibration program and a gyro calibration method that suppresses the influence of noises during calibration. The present invention further provides a gyro calibration apparatus and method that measure the position and the orientation of a robot. Which are necessary for the calibration of the gyro, in a simple manner. The following apparatus, program and method according to the present invention contribute to at least one of the above-described purposes.

In an aspect of the present invention, a gyro calibration apparatus is provided, that includes a beam emission means for emitting a beam of light, a beam position detection means for detecting the position illuminated by the emitted beam of light, a calculation means for calculating at least one of a position and an orientation of the mobile object in accordance with the illuminated position detected by the beam position detection means, and a calibration means that calibrates the gyro in accordance with the at least one of the position and the orientation of the mobile object calculated by the calculation means.

According to the aspect of the present invention, the mobile object, such as a robot, emits a beam of light to a target wall surface. At least one of the position and orientation of the robot is calculated based on the measured position on the target wall surface illuminated by the beam of light. Accordingly, the position or orientation of the robot is easily measured without transporting or setting a large jig, etc.

The gyro-calibration apparatus of the present invention may include a means for measuring the distance from the robot to the illuminated position. The calculation means calculates at least one of the position and orientation of the robot in accordance with the distance from the robot to the illuminated position in addition to or instead of the illuminated position

In this case, the orientation or position of the robot is easily measured, if the distance between the robot and the target wall surface is easily measured or the distance is determined in advance.

The gyro calibration apparatus of the present invention may include a means for measuring a moving distance of the robot while the robot rotates. The moving distance is a distance of which the robot moves as it rotates. The calculation means calculates at least one of the position and orientation of the robot in accordance with the moving distance of the robot in addition to or instead of the illuminated position.

Because the moving distance of the robot before and after the rotation is used, the orientation or position of the robot is easily measured when the measurement of the moving distance of the robot is easy.

The beam emission means may emit the beam of light in a plurality of directions.

If the multiple beams of light are emitted to multiple target wall surfaces that intersect with each other, multiple pieces of measured data can be used, or a target wall surface can be selectively used to make the measurement easier.

The beam position detection means may be a position-measuring device, mounted on the robot or an external position-measuring device provided separately from the robot.

According to this aspect of the invention, the position-measuring means may be a position-measuring device that is mounted on or separate from the mobile object. In either case, the gyro calibration apparatus can be configured to fit (be appropriated) for each measuring.

In another aspect of the present invention provides a gyro calibration apparatus that calibrates a gyro for detecting position information mounted on a mobile object that includes an initial-value obtaining means for obtaining an initial position value, which is a position of the mobile object set at an initial position; a detected-value obtaining means for obtaining a plurality of values detected by the gyro for a predetermined period while the mobile object remains in the initial position; an instruction means for instructing the detected-value obtaining means to restart obtaining a plurality of values when a disturbance is detected; and a calibrated-value setting means that determines a calibrated position value based on the plurality of values obtained by the detected-value obtaining means, and for setting the calibrated position value to a calibrated value for the initial position value.

According to the aspect of the present invention, the mobile object, such as a robot, is set to an initial position and the multiple values detected by the gyro are consecutively obtained at the position. Then, if the detected values are successfully obtained over a predetermined calibration period, the calibrated value is determined (set) based on the multiple detected values. If a disturbance occurs, the calibration period is reset and the process to obtain the detected values is repeated. Accordingly, the disturbance is eliminated and the initial value for the measuring by the gyro can be set (determined) by using the multiple detected values obtained over the predetermined time period. Thus, the calibration is performed with high reliability.

The calibrated-value setting means may calculate an average of the plurality of values obtained by the detected-value obtaining means and may set the average to the calibrated value.

In this aspect, because the average of multiple detected values obtained during the calibration period is set to the calibrated value, the influence of an accidental noise is suppressed by averaging.

The gyro calibration apparatus according to the present invention may further include a status output means for outputting a signal indicating that calibration is in progress. In this case, because the status of calibration is indicated in the period from the start to the end of the calibration, bystanders are warned and the occurrence of noises can be suppressed.

The gyro calibration apparatus according to the present invention may further include an alarm means for outputting an alarm signal that indicates the occurrence of the disturbance. Thus, because the robot outputs an alarm signal when a disturbance occurs, the bystanders are warned after the fact and the suppression of noises becomes easier thereafter.

In another aspect of the present invention, a robot having a gyro is provided. The robot includes a gyro that detects a position of the robot, and a calibrator that calibrates the gyro. The calibrator includes an initial-value obtaining means for obtaining an initial position value, which is a position of the robot set at an initial position, detected by the value obtaining means for obtaining a plurality of values detected by the gyro for a predetermined period while the robot remains in the initial position, an instruction means for instructing the detected-value obtaining means to restart obtaining a plurality of gyro when a disturbance is detected, and calibrated-value setting means for determining a calibrated position value based on the plurality of values obtained by the detected-value obtaining means and for setting the calibrated position value to a calibrated value for the initial position value.

In further aspect of the present invention, a program for calibrating a gyro is provided. A calibrator that calibrates a gyro for detecting position information performs the program. The program includes the steps of obtaining an initial position value, which is the position of the robot when it is initially set in position; obtaining a plurality of values detected by the gyro for a predetermined period while the robot remains in the initial position; providing an instruction to restart the obtaining of the plurality of values when a disturbance is detected; determining a calibrated position value based on the obtained plurality of values; and setting the calibrated position value to a calibrated value for the initial position value.

As described above, according to the gyro calibration apparatus, in a robot having a gyro, a gyro calibration program, and a gyro calibration method of the present invention, noises are suppressed during the calibration even if the gyro is easily influenced by noises. In addition, according to the gyro calibration apparatus of the present invention, the position or orientation can be easily measured for the calibration of gyro.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a view illustrating a configuration of a robot having an optical gyro according to an embodiment of the present invention;

FIG. 2 is a view illustrating a configuration of a position-measuring device according to the embodiment of the present invention;

FIG. 3 is a view that generally explains symbols and reference numerals used in a process that calculates a rotation angle of the robot according to the embodiment of the present invention;

FIG. 4 is a first example for determining the rotation angle of the robot according to the embodiment of the present invention;

FIG. 5 is a third example for determining the rotation angle of the robot according to the embodiment of the present invention;

FIG. 6 is a fourth example for determining the rotation angle of the robot according to the embodiment of the present invention;

FIG. 7 is a fifth example for determining the rotation angle of the robot according to the embodiment of the present invention;

FIG. 8 is a sixth example for determining the rotation angle of the robot according to the embodiment of the present invention;

FIG. 9 a view that explains a calculation of the position of the robot according to the embodiment of the present invention;

FIG. 10 is a flowchart illustrating a calibration process of a gyro mounted on the robot according to the embodiment of the present invention;

FIG. 11 is a chart illustrating a relationship among the change in a detected values of optical the gyro over time, disturbance and calibration period.

### DETAILED DESCRIPTION OF THE PREFERRED EMBODIMENTS

An embodiment of the present invention is explained with reference to the drawings. In the following description, an optical gyro, which includes an optical element, is used for the positioning control of a robot. However, a gyro other than an optical gyro may be used if such a gyro has the precision/accuracy sufficient for the positioning control of the robot. The robot in the following description is a robot for the purpose of entertainment. However, a robot for other purposes may be used, if such a robot has a gyro. In addition, in the following description, the calibrator is a part of a robot controller provided in the robot. However, the calibrator may be a separate device that is not mounted on the robot and may be linked with the robot by a wired or a wireless connection. An indicator may also be mounted on the robot in the following description, but the invention does not exclude a separate device that is not mounted on the robot and which may be linked with the robot by a wired or a wireless connection or through a network, such as a local area network (LAN), etc. In the following description, a position-measuring device has an external camera that is not mounted on the robot; however, a position detector that is mounted on the robot may be used instead of the external camera. In the following description, an angle or angular speed is calibrated; however, the angle or angular speed may be converted into a coordinate position, and the coordinate position may be calibrated instead. Therefore, in the following description, the position information or position data includes an angle or angular speed. The numerical values appearing below are merely examples for the purpose of explanation and should not be construed as a limitation of the invention.

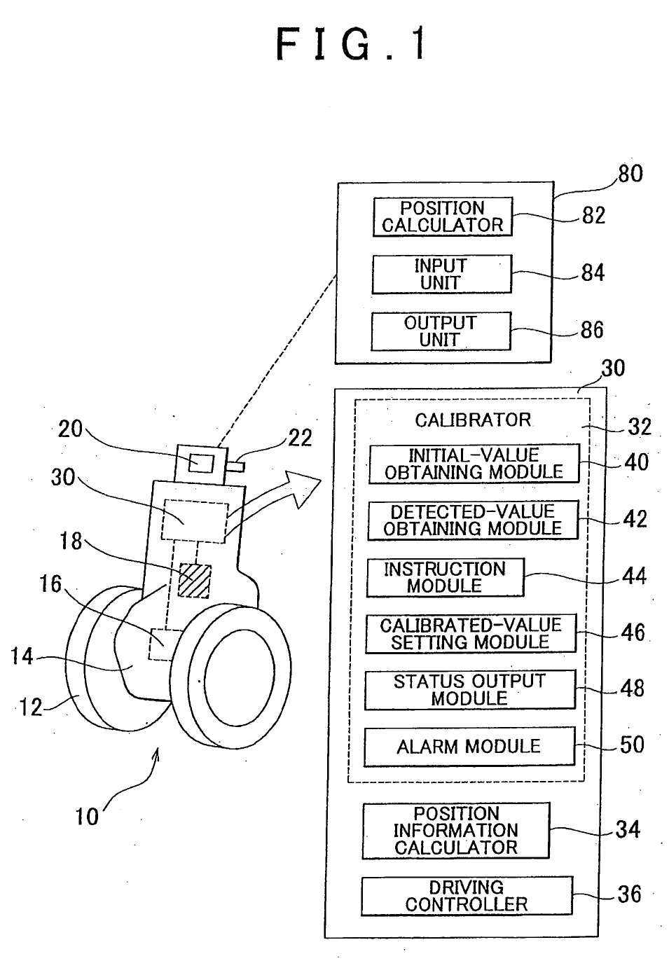

FIG. 1 is a view illustrating an example of a configuration of a robot 10 used for the purpose of entertainment. The robot 10 includes two wheels 12 and a body 14. The robot performs an entertainment action, such as moving to a predetermined direction and to a predetermined position, rotating the body 14 at an appropriate timing, bowing, waving arms (not shown), and the like, according to a predetermined program. The robot 10 may also include a driving unit 16, which moves the wheels 12 and the body 14; an optical gyro 18, which detects the movement of the robot 10; an indicator 20, which indicates information related to the movement of the robot 10; and a controller 20, which is connected with these elements and controls the overall movement of the robot 10. The robot 10 may also be equipped with a light emitter 22 that emits a beam of light to illuminate an appropriate target object. The robot 10 is linked with a remote controller 80 by wired or wireless connection. The remote controller 80 includes a position calculator 82 that calculates a position or orientation (direction) of the robot 10 using the beam of light emitted from the light emitter 22, an input unit 84, and an output unit 86 for inputting and outputting data, respectively.

The driving unit 16 is a driving mechanism that rotates the wheels 12, changes the direction of the wheels 12, rotates the body 14 around an axis and swings the body 14. The driving unit 16 may be implemented by multiple small motors, for example.

The optical gyro 18 is an element that detects the angular speed in the direction of three, mutually orthogonal, axes. The three mutually orthogonal-axes may be defined relative to any reference (line or plane), such as the axis of earth or the ground surface. In the latter case, the optical gyro 18 detects three angular speeds, i.e., the changes over time in the rotation angles φ, ψ and θ respectively around the z-axis, x-axis and y-axis. The z-axis is vertical to the ground surface, and the x-axis and y-axis are parallel to the ground surface and perpendicular to the z-axis. The detected angular speeds are sent to the controller 30, and used in a position information calculation process that calculates a present position, etc. of the robot 10.

The indicator 20 provides an indication according to the movement of the robot 10. For example, the indicator 20 may be a lamp or a LED that blinks on and off, a LCD display that displays a character thereon, or a speaker that produces a voice sound or music. In addition, during the calibration of the optical gyro 18, the indicator 20 indicates the start of the calibration, the calibration in progress, an alarm when noises occur, and so on, as described below.

The controller 30 is an electronic circuit, which is mounted on the robot 10. The controller 30 calculates, for example, the current position of the robot 10 based on the signals detected by the optical gyro 18, and provides instructions to the driving unit 16 and indicator 20 according to the result of the calculation, to make the robot 10 move and perform a variety of entertainment actions. The controller 30 may be a microprocessor, or the like.

The controller 30 includes a calibrator 32, which calibrates the optical gyro 18; a position information calculator 34, which calculates position information of the robot using values detected by the optical gyro 18; and a driving controller 36, which provides instructions to the driving unit 16 according to the position information and an entertainment program. The calibrator 32 includes an initial-value obtaining module 40, which obtains an initial value for calibration; a detected-value obtaining module 42, which obtains values detected by the optical gyro 18 for calibration; an instruction module 44; a calibrated-value setting module 46; a status output module 48; and an alarm module 50. The instruction module 44 determines whether a disturbance occurs, and provides an instruction to restart the calibration when such disturbance occurs. The calibrated-value setting module 46 sets a calibrated value based on the values detected by the optical gyro 18, when the optical gyro 18 succeeds in detecting values over the entire predetermined calibration period. The status output module 48 outputs a signal indicating that, for example, the calibration is in progress. The alarm module 50 alerts when a disturbance occurs. These functions are implemented (realized) by software, in particular, by running corresponding computer programs, such as a calibration program, a position information calculating, or an entertainment program. A part of the functions may be implemented by hardware.

The light emitter 22 is attached to the body 14 of the robot 10, and emits a beam of light. In more detail, the light emitter 22 is an electronic component that emits a laser beam. The light emitter 22 emits a beam of light to illuminate an appropriate target wall surface, in order to measure the position of the robot 10. The position on the target wall surface illuminated by the emitted beam of light moves synchronously with the position and orientation (direction) of the body 14 of the robot 10. Accordingly, the illuminated position is used as a light pointer associated with the position and orientation of the body 14 of the robot 10. In this embodiment, a laser beam is used, and the position on the target wall surface illuminated by the laser beam is called a laser point. The light axis of the light beam is set so that the light beam is emitted from the center of rotation of the body 14 of the robot 10. One light emitter 22 or two light emitters 22 may be provided. If two light emitters 22 are provided, the two light emitters 22 are located so that the light axes thereof form a predetermined angle, for example, the light emitters may be at a right angle to each other.

The remote controller 80 is a system terminal that performs functions that are more conveniently performed at a separate external terminal, in comparison with when the functions are performed by the controller 30 of the robot 10. However, the functions of the remote controller 80 may be (integrally) performed by the controller 30. In the embodiment shown in FIG. 1, the remote controller 80 includes a position calculator 82 that calculates at least one of the position and orientation (direction) of the robot 10, in particular, the position calculator 82 obtains at least the rotation angle of the robot 10. The position measuring function of the robot 10 is provided, in particular, to determine the position of the robot 10 during the calibration of the optical gyro 18, i.e., to determine the rotation angle, which is the orientation (direction) of the robot 10 during the calibration. The input unit 84 inputs data, and so on, to the position calculator 82. The output unit 86 outputs the rotation angle of the robot 10 calculated by the position calculator 82 to the controller 30, in order for the calibrator 32 to use the rotation angle of the robot 10 as an initial value of calibration. The functions of the remote controller 80, as well as those of the controller 30, may be implemented by software, in particular, by running corresponding programs, such as a program for measuring a position of the robot. A part of the functions of the remote controller 80 may be implemented by hardware.

The calibration apparatus of the optical gyro mounted on the robot 10 includes the function of measuring the position of the robot, which is performed mainly by the position calculator 82, and a function of narrowly-defined calibration of the optical gyro, which is performed mainly by the calibrator 32. The calibration of the optical gyro 18 starts with setting the robot 10 at an initial position. Then, the optical gyro 18, which produces the position information of the robot, is calibrated at the initial position. For example, the robot 10 is set or positioned to face a reference wall, and is moved to a predetermined initial position, or is rotated by a predetermined angle. At this time, the position of the robot, such as the rotation angle, is measured. Then, the optical gyro is calibrated at the initial position, by use of the measured rotation angle as a reference value. After the calibration, the optical gyro detects the position of the robot in real time using the calibrated value (position) as a reference value, and the robot performs an action, such as an entertainment action, thereafter.

In more detail, in the calibration of the optical gyro mounted on the robot, the robot 10 is set on the floor with a positioning jig, etc, and is rotated to the predetermined direction to be positioned at an initial position for calibration. For example, the robot is rotated +30 degrees (counterclockwise) around the z-axis, which is vertical to the floor, to be positioned at the initial position for calibration. However, the rotation angle may be set to any value. The position calculator 82 measures the rotation angle, such as +30 degrees, accurately and the calibrator 32 calibrates the optical gyro 18 to achieve the measured value at the initial position. In the following description, the setting and measuring of the initial position are explained first, and then an entire calibrating operation using the information of the initial position is explained.

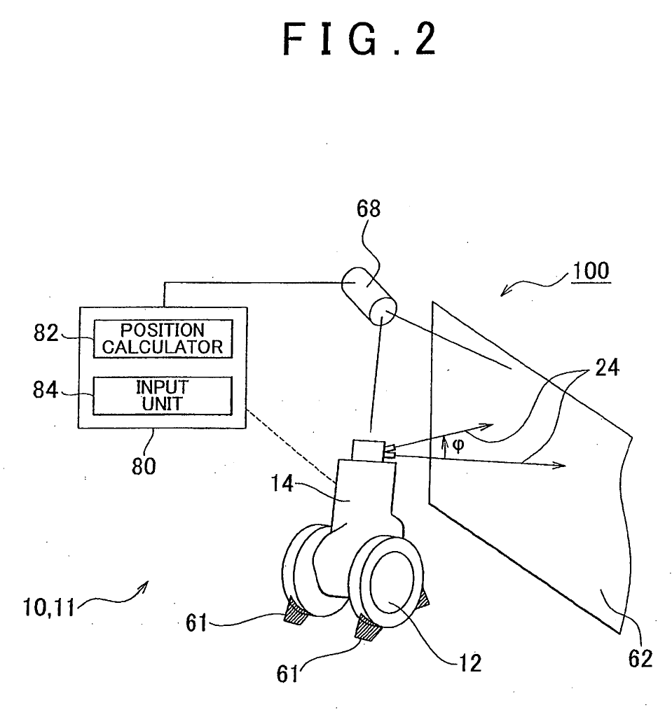

FIG. 2 is a view illustrating the configuration of the position-measuring device 100 that measures the position of the robot. Such measurement of the position of the robot includes the setting of the robot 10 at the initial position. The core of the position-measuring device 100 is the position calculator 82. The position-measuring device 100 includes an external camera 68 in addition to the position calculator 82 and light emitter 22, etc., which are a part of the robot 10 as explained above with reference to FIG. 1. The external camera measures the position of the laser point on the target wall surface 62 illuminated by the laser beam 24. The data, such as the measured position of the laser point, is sent to the position calculator 82 via a signal line. As described above, the external camera 68 may instead be mounted on the robot 10. In such a case, the position-measuring device 100 will be a component of the robot 10. In addition, the positioning jig 61 on the floor, which is used for setting or positioning of the robot 10, and the target wall surface 62 contribute to the functions of the position-measuring device 100.

In the initial position setting and the position measuring of the robot 10, initially, the two wheels 12 of the robot 10 are aligned with the jig 61 on the floor. This position is the reference position. The robot is rotated by a predetermined angle, such as φ=+30 degrees, and fixed at the position. This position (condition) of the robot is an initial position (condition) for calibration. The gyro 18 is not used to measure the rotation angle φ, which is a change in position between the robot 10 at the reference position and the robot 11 at the initial position. Instead, the rotation angle φ is determined by geometrically calculating the positions of the robots 10 and 11 relative to the target wall surface 62. Therefore, the position of the laser point, which is the position on the target wall surface 62 illuminated by the laser beam 24, is observed (monitored) and measured by the external camera 68.

Generally, the position calculator 82 geometrically determines the rotation angle φ of the robot 10 based on the various position data obtained by the external camera 68. At this time, a little ingenuity in determining the relative position of the robot 10 and the target wall surface 62 decreases the number of measurements needed to determine the rotation angle φ. Several methods for obtaining the rotation angle are explained hereinafter. At first, a general definition of symbols and reference numerals, such as the coordinate system for calculating the rotation angle, will be explained. Then, examples of detailed methods of position measuring and rotation angle calculation will be explained. The explanation of the detailed methods of measuring and calculation starts with the method that performs simple measuring by the device in the relative positioning of the robot. Then, the more general methods of measuring and calculating the rotation angle will be explained.

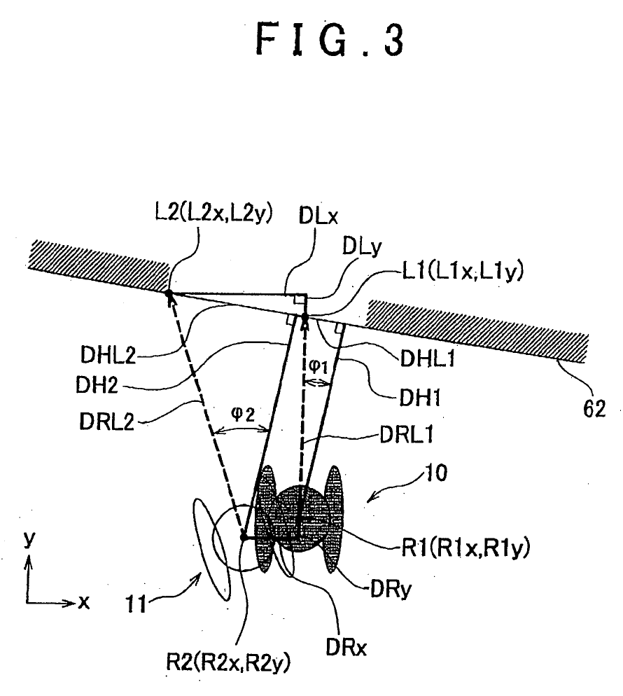

FIG. 3 is a view that generally explains the symbols, such as the coordinate system, used in the process for calculating the rotation angle between the robots 10 and 11. FIG. 3 is a top view that illustrates the target wall surface 62, the robot 10 positioned before rotation and the robot 11 positioned after rotation, as well as the x-y reference coordinate system. The position of the robot 10 before rotation is indicated by R1(R1x, R1y), and the position of the robot 11 after rotation is indicated by R2(R2x, R2y). The positions of the robots 10 and 11 are the positions of the center axis around which the body 14 of the robot rotates. L1(L1x, L1y) indicates the position of the laser point, i.e. the position on the target wall surface 62 illuminated by the beam of light from the robot before rotation, and L2(L2x, L2y) indicates the position of the laser point after rotation.

The angles φ1 and φ2 discussed herein are measured from the normal or perpendicular line to the target wall surface 62. The angle φ1 is an angle of the (incident) beam of light, which is emitted from the robot 10 before rotation and is incident on the target wall surface 62. The angle φ2 is an angle of the (incident) beam of light, which is emitted from the robot 11 after rotation and is incident on the target wall surface 62. Therefore, the rotation angle φ3 between the robot 10 before rotation and the robot 11 after the rotation is calculated by φ3=φ2−φ1.

The perpendicular distances from robots 10 and 11 to the target wall surface 62 are respectively indicated, by DH1 and DH2. The distances from the robots 10 and 11 to the corresponding laser points L1 and L2 on the target wall surface 62 are respectively indicated by DRL1 and DRL2. The distances from the intersections of the target wall surface 62 and perpendiculars drawn from the robots 10 and 11 before and after rotation to the target wall surface 62, to the corresponding laser points L1 and L2 on the target wall surface 62 are respectively indicated by DHL1 and DHL2. DRx and DRy indicate the x-axis component and y-axis component of the moving distance from the robot 10 before rotation to the robot 11 after rotation, respectively.

The x-y reference coordinate system may thus established independent of the target wall surface 62 or the robot 10 in advance. The target wall surface 62 is not parallel to the x-axis of the reference coordinate system, generally. Nevertheless, in the next description, the target wall surface 62 is assumed to be parallel with the x-axis for simplicity.

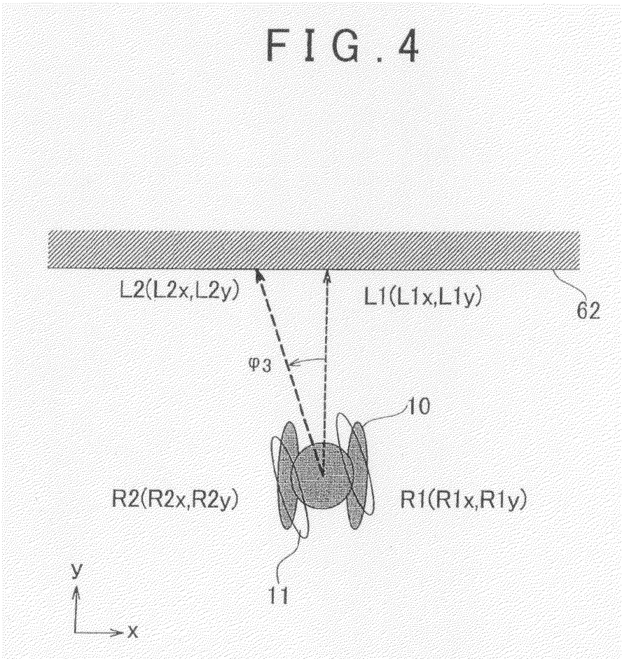

FIG. 4 is a view that illustrates a first example to determine the rotation angle φ3. In this example, the target wall surface 62 is parallel to the x-axis of the reference coordinate system, and the incident beam of light is normal to the target wall surface 62 before rotation. The position of the positioning jig 61 relative to the target wall surface 62 can be determined in advance to establish the above arrangement. In FIG. 4, the robot 10 does not change the horizontal position, and thus rotates on the spot. In other words, R1 is equals to R2 (i.e. R1(R1x, R1y) R2(R2x, R2y)). In this case, the calculation of the rotation angle φ3 requires fewer measurements, as described below.

The laser point L1 is the position on the target wall surface 62 illuminated with the incident beam of light emitted in a direction normal to the target wall surface from the robot 10 before rotation. The laser point L2 is the position illuminated with the beam of light emitted from the robot after rotation without changing its (horizontal) position. The distance from the robot 10 to the laser point L1 on the target wall surface 62 is indicated by DH1 and is calculated by:

DH1=L1y−R1y

Further, the x-axis component DLx of the moving distance on the wall surface between the laser point L1 and the laser point L2 is calculated by:

DLx=L1x−L2x

Accordingly, the rotation angle φ3 is calculated by:

φ3=tan⁻¹(DLx/DH1)=tan⁻¹((L1x−L2x)/(L1y−R1y))

Generally, the following formula may also be used.

φ3a tan 2(DLx,DH1)=a tan 2((L1x−L2x),(L1y−R1y))

Thus, the rotation angle φ3 is obtained by measuring the two points, i.e. the position R1(R1x, R1y) of the robot and the position L2(L2x, L2y) of the laser point. The rotation angle φ3 is also obtained from the two distance values, i.e., the distance DH1, which is a normal distance from the robot to the target wall surface, and the moving distance DL1, which is the distance on the target wall surface between the positions L1 and L2.

Alternatively, the rotation φ3 may be calculated based on the distance between the position R2 of the robot 11 after rotation and the position of the laser point L2, as follows.

φ3=cos⁻¹(DH1/DRL2)=cos⁻¹((L1y−R1y)/DRL2)

In other words, the rotation angle φ3 is calculated based on the distances DH1 and DRL2, which are the distance between the robot and the laser point L1 before rotation and the distance between the robot and the laser point L2 after rotation, respectively. Similarly, the rotation angle φ3 may also be determined using the distance DRL2 between the robot and the laser point L2, and the moving distance DLx, which is the distance on the target wall surface between the positions L1 and L2, based on the following formula.

φ3=sin⁻¹(DLx/DRL2)=sin⁻¹((L1x−L2x)/DRL2)

In the second example that determines the rotation angle φ3, the beam of light before the robot rotates is incident upon the target wall surface 62 obliquely rather than at a right angle as shown in FIG. 4. In this example, similar to the first example, the target wall surface 62 is parallel to the x-axis of the reference coordinate system, and the robot 10 rotates on the spot without changing its (horizontal) position before and after the rotation. In other words, R1 equals to R2 (i.e. R1(R1x, R1y)=R2(R2x, R2y)). In this case, the rotation angle φ3 is obtained as follows.

In this example, the laser point L1 is a position on the target wall surface 62 illuminated by the beam of light emitted from the robot 10 before rotation. The laser point L2 is the position after the robot rotates on the spot. Before and after rotation of the robot, the angles φ1 and φ2 of the (incident) beams of light that are respectively emitted from the robots 10 and 11 and are incident on the corresponding laser points L1 and L2, are obtained by the following formulas. Note that the angles φ1 and φ2 discussed herein are measured from the perpendicular line to the target wall surface 62,

φ1=tan⁻¹((L1x−R1x)/(L1y−R1y))

φ2=tan⁻¹((L2x−R1x)/(L2y−R1y))

The rotation angle φ3 is calculated by the formula below.

φ3=φ2−φ1

As a result, the rotation angle φ3 is determined using three position values, i.e. the position, R1(R1x, R1y) of the robot and the positions L1(L1x, L1y) and L2(L2x, L2y) of the laser points.

The x-axis component DLx and the y-axis component DLy of the moving distance from the laser point L1 to the laser point L2 is measured.

DLx=L1x−L2x

DLy=L1y−L2y

In view of the above formulas, the rotation angle φ3 is obtained based on the following formulas.

φ1=tan⁻¹((L1x−R1x)/(L1y−R1y))

φ2=tan⁻¹((L2x−R1x)/(L2y−R1y))tan⁻¹((L1x−DLx−R1x)/(L1y−DLy−R1y))

φ3=φ2−φ1

As described above, the rotation angle φ3 is calculated by using the position R1(R1x, R1y) of the robot, the position L1(L1x, L1y) of the laser point, and the moving distances DLx and DLy on the target wall surface.

The rotation angle φ3 may be determined based on the following formulas, if the perpendicular distance DH1 (before rotation) from the robot 10 to the target wall surface 62 and the perpendicular distance DH2 (after rotation) from the robot 11 to the target wall surface 62 are measured.

φ1=tan⁻¹((L1x−R1x)/(DH1))

φ2=tan⁻¹((L2x−R1x)/(DH2))

φ3=φ2−φ1

In this case, L1x and L2x can be geometrically determined using the position R1(R1x, R1y) of the robot, and the perpendicular distances DH1 and DH2. Thus, the rotation angle φ3 can also be determined using the position R1(R1x, R1y) of the robot, and the perpendicular distances DH1 and DH2.

If the distances DRL1 (before rotation) and DRL2 (after rotation), which are respectively the distances between the positions of the robot and the corresponding laser points before and after rotation, are measured, the rotation angle φ3 is determined by:

φ1=sin⁻¹((L1x−R1x)/(DRL1))

φ2=sin⁻¹((L2x−R1x)/(DRL2))

φ3=φ2−φ1

Alternatively, φ3 may be determined by:

φ1=cos⁻¹((L1y−R1y)/(DRL1))

φ2=cos⁻¹((L2y−R1y)/(DRL2))

φ3=φ2−φ1

R1y is geometrically determined using the positions L1(L1x, L1y) and L2(L2x, L2y) of the laser points and the distances DRL1 and DRL2 between the positions of the robot (before and after rotation) and corresponding positions L1(L1x, L1y) and L2(L2x, L2y) of the laser points. Accordingly, φ3 is determined using the positions of the laser points L1(L1x, L1y) and L2(L2x, 12y) and the respective distances between the robot (before and after rotation) and positions of the laser points DRL1 (before rotation) and DRL2 (after rotation).

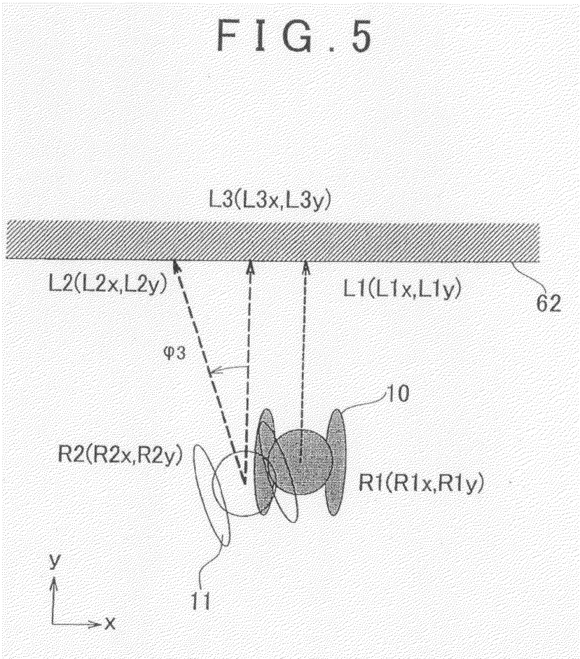

FIG. 5 is a view illustrating a third example to determine the rotation angle φ3. In FIG. 5, the target wall surface 62 is defined parallel to the x-axis of the reference coordinate system. The beam of light emitted from the robot before the rotation is incident upon the target wall surface 62 obliquely rather than at a right angle. In addition, the positions of the robot before and after the rotation are different. In other words, the position R1(R1x, R1y) of the robot 10 before rotation is different from the horizontal position R2(R2x, R2y) of the robot 11 after the rotation. Thus, the example shown in FIG. 5 is a relatively general case. In such a case, the rotation angle φ3 is obtained as follows.

Before and after the rotation, the perpendicular distances (distances along the line parallel to the y-axis of the reference coordinate system) from the respective robots 10 and 11 to the target wall surface 62 are determined by the formulas below.

DH1=L1y−R1y

DH2=L2y−R2y

Then, DHL1 (before rotation) and DHL2 (after rotation), which are respectively the distances before and after the rotation, between the points at which the perpendicular line drawn from the robots 10 and 11 to the target wall surface 62 intersect with the target wall surface 62, and the laser points L1 and L2, are determined from the following formulas. Note that the distances DHL1 and DHL2 are distances along a line parallel to the x-axis of the reference coordinate system.

DHL1=L1x−R1x

DHL2=L2x−R2x

In view of the above, the angles φ1 and φ2 before and after the rotation are determined from the following formulas.

φ1=tan⁻¹(DHL1/DH1)=tan⁻¹((L1x−R1x)/(L1y−R1y))

φ2=tan⁻¹(DHL2/DH2)=tan⁻¹((L2x−R2x)/(L2y−R2y))

Alternatively, the following formulas may be used.

φ1=a tan 2(DHL1,DH1)a tan 2((L1x−R1x),(L1y−R1y))

φ2=a tan 2(DHL2,DH2)=a tan 2((L2x−R2x),(L2y−R2y))

When the robot moves horizontally, the rotation angle φ3 is obtained by use of the angles φ1 and φ2 determined above, as follows.

φ3=φ2−φ1

Accordingly, the angle φ3 is determined from the positions R1(R1x, R1y) and R2(R2x, R2y) of the robot before and after the rotation, and the positions L1(L1x, L1y) and L2(L2x, L2y) of laser points.

If DLx and DLy, which are x-axis and y-axis components of the moving distance from the laser point L1 to the laser point L2 on the wall, are measured, the following formulas regarding DLx and DLy are used for the calculation of φ3.

DLx=L1x−L2x

DLy=L1y−L2y

Then, the rotation angle φ3 is determined by:

φ1=tan⁻¹((L1x−R1x)/(L1y−R1y))

φ2=tan⁻¹((L2x−R2x)/(L2y−R2y))=tan⁻¹((L1x−DLx−R2x)/(L1y−DLy−R2y))

φ3=φ2−φ1

Thus, the rotation angle α3 is determined by use of the positions R1(R1x, R1y) and R2(R2x, R2y) of the robot, the position L1(L1x, L1y) of laser point and the moving distance DLx and DLy on the wall.

When the target wall surface 62 is parallel to the x-axis of the reference coordinate system, the moving distance DLy is zero.

DLy=L1y−L2y=0

Accordingly, the formulas described above can be simply written as follows.

φ1=tan⁻¹((L1x−R1x)/(L1y−R1y))

φ2=tan⁻¹((L2x−R2x)/(L2y−R2y))=tan⁻¹((L1x−DLx−R2x)/(L1y−R2y))

Then, the rotation angle φ3 is determined by:

φ3=φ2−φ1

Under this condition, if the distances DRL1 (before movement) and DRL2 (after movement) from the robot to respective laser points before and after the movement are measured, φ1 and φ2 are calculated by use of them, as follows:

φ1=sin⁻¹((L1x−R1x)/(DRL1))

φ2=sin⁻¹((L2x−R2x)/(DRL2))

Accordingly, the rotation angle φ3 is determined by:

φ3=φ2−φ1

Alternatively, φ1 and φ2 may be calculated as follows.

φ1=cos⁻¹((L1y−R1y)/(DRL1))

φ2=cos⁻¹((L2y−R2y)/(DRL2))

Then, φ3 is calculated by:

φ3=φ2−φ1

As described above, the rotation angle φ3 is determined by use of the positions R1(R1x, R1y) and R2(R2x, R2y) of the robot, the positions L1(L1x, L1y) and L2(L2x, L2y) of laser points and the distances DRL1 and DRL2 from the robot to respective laser points.

Further, if DRx and DRy, which are respectively x and y components of moving distance of the robot, are measured, φ1 and φ2 are calculated by use of DRx and DRy, as follows.

DRx=R1x−R2x

DRy=R1y−R2y

φ1=sin⁻¹((L1x−R1x)/(DRL1))

φ2=sin⁻¹((L2x−R2x)/(DRL2))=sin⁻¹((L2x+DRx−R1x)(DRL2))

The rotation axis φ3 is calculated by:

φ3=φ2−φ1

Thus, the rotation axis φ3 is obtained using the positions L1(L1x, L1y) and L2(L2x, L2y) of laser points, the position R1(R1x, R1y) of the robot, the distances DRL1 and DRL2 from the robot to respective laser points, and moving distances DRx and DRy of the robot.

In the above example, the function tan⁻¹ may be used, instead of the function sin⁻¹. In such a case, the moving distances DRx and DRy of the robot are measured.

DRx=R1x−R2x

DRy=R1y−R2y

Using the above formulas, φ1 and φ2 are calculated by use of DRx and DRy.

φ1=tan⁻¹(DHL1/DH1)=tan⁻¹((L1x−R1x)/(L1y−R1y))

φ2=tan⁻¹(DHL2/DH2)=tan⁻¹((L2x−R2x)/(L2y−R2y))=tan⁻¹((L2x+DRx−R1x)/(L2y+DRy−R1y))

The rotation angle φ3 is determined by:

φ3=φ2−φ1

Thus, the rotation angle α3 is determined by using the positions L1(L1x, L1y) and L2(L2x, L2y) of the laser points, the position R1(R1x, R1y) of the robot and the moving distances DRx and DRy of the robot.

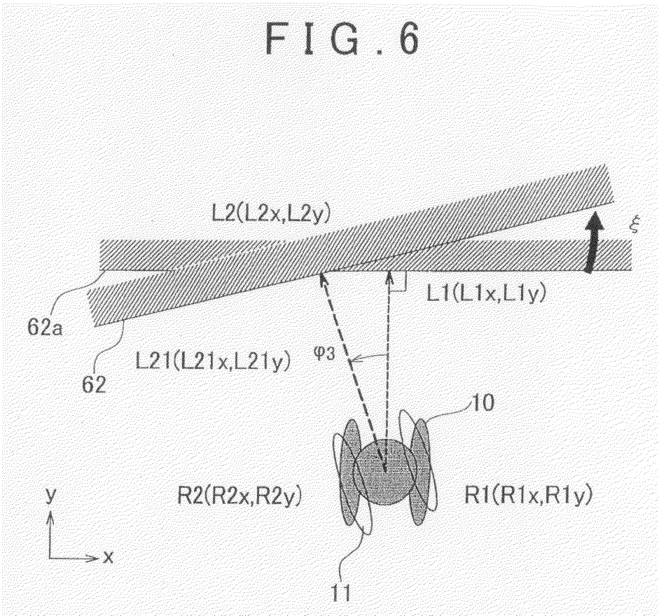

In a fourth example to determine the rotation angle φ3, when the target wall surface 62 is not parallel to the x-axis of the reference coordinate system, the inclination of the target wall surface 62 is corrected. FIG. 6 shows such an example. In FIG. 6, the target wall surface 62 is inclined at the angle ξ with respect to the x-axis of the x-y reference coordinate system. The robot 10 rotates at the position (on the spot) and thus does not change its horizontal position before and after the rotation. In other words, R1 equals to R2 (i.e. R1(R1x, R1y)=R2(R2x, R2y)). It is assumed that the position of the laser point before rotation is always in the same position regardless of the inclination angle of the target wall surface 62. The position of the laser point after the rotation is L21(L21x, L21y), rather than L2(L2x, L2y), because the target wall surface 62 is inclined. In this example, L2 is the position of the laser point on a virtual wall surface 62a, which is parallel to the x-axis.

The correction of the inclination ξ of the target wall surface 62 with respect to the x-y reference coordinate system is performed as follows. The distance DL1L21 from L1 to L21 is determined by, for example, the Pythagorean theorem.

DL1L21=SQRT((L1x−L21x)̂2+(L1y−L21y)̂2)

By use of the DL1L21, the position L2(L2x,L2y) of the laser point is determined based on the following formulas.

L2x=Lx−DL1L21 cos ξ

L2y=L1y−DL1L21 sin ξ

The obtained coordinate L2 is the position of the laser point on the virtual wall surface 62a, to which the position L21 of the actual laser point on the target wall surface 62 is mapped. As described above, the virtual wall surface 62a is parallel to the x-axis. By this correction using the mapping, the rotation angle φ3 is determined by the same method as that explained above when the target wall surface is parallel to the x-axis.

If the incident laser beam before rotation is also inclined, the position L1 of the laser point on the virtual wall surface 62a, which is not inclined, is determined in the same manner as that described above when the target wall surface is inclined. Then, the rotation angle φ3 is determined using the obtained L1 and L2.

When the target wall surface is not flat, the positions L1 and L2 of the laser points on the virtual wall surface, which is parallel to the x-axis of the x-y reference coordinate system, are obtained from the illuminated positions of the laser points on the actual target wall surface, in the same manner as that described above when the target wall surface is not parallel to the x-axis. The rotation angle φ3 is determined using the obtained L1 and 12. In this case, the positions of the actual wall surface relative to the reference coordinate system are measured in advance.

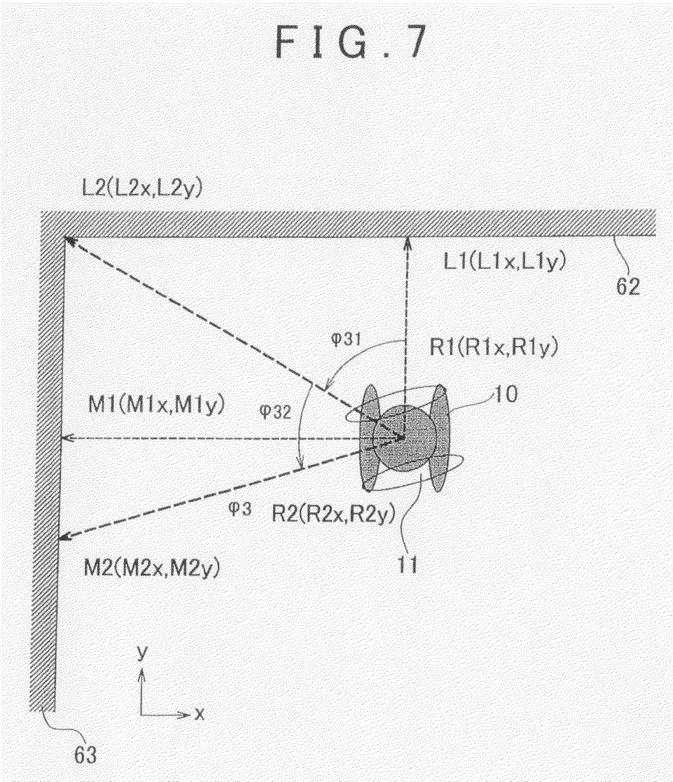

In the fifth example for determining the rotation angle φ3, there are two target wall surfaces and the robot emits two laser beams. Even if there are two target wall surfaces, when the positions of the laser-points remain in a single target wall surface before and after rotation, the rotation angle φ3 may be determined by the exact process as that of determining φ3 using only one target surface. However, if the rotation angle is large, the positions of laser points may cover two different target wall surfaces before and after the rotation. In this case, the methods for determining the rotation angle φ3 described above cannot be used. FIG. 7 is a view illustrating such a situation.

In FIG. 7, the first target wall surface 62 is perpendicular to the second target wall surface 63. The optical axes of the two laser beams emitted from the robot are perpendicular to each other. Each laser beam is emitted from the robot to each target wall surface 62 and 63 before the rotation of the robot. In this example, the robot rotates on the spot, thus, its horizontal position before and after the rotation remains unchanged. In other words, R1 equals to R2 (i.e. R1(R1x, R1y)=R2(R2x, R2y)).

In this example, L1(L1x, L1y) is the position of the laser point on the first target wall surface 62 illuminated by the laser beam from the robot 10 before rotation. M1(M1x, M1y) is the position of the laser point on the second target wall surface 63 illuminated by the laser beam from the robot 10 before rotation. As to the laser point after the rotation, because the rotation angle φ3 is large, the laser point that was at the position L1(L1x, L1y) on the first target wall surface 62 moves to the position M2(M2x, M2y) on the second target wall surface 63. The laser point that was at the position M1(M1x, M1y) on the second target wall surface 63 before the rotation moves off of the target wall surface 63 after the rotation, and thus is not shown in FIG. 7.

In this case, the angle χ or the relative position between the target wall surface 62 and the target wall surface 63 is set in advance. Accordingly, when the rotation moves the laser point from the first target wall surface 62 to the second target wall surface 63, the rotation angle φ3 is determined by adding the rotation angle φ31 and the rotation angle φ32. The rotation angle φ31 is the rotation angle when the laser point moves from the position L1 to the end of the first target wall surface 62. In more detail, the end of the first target wall surface 62 is an intersection of the first target wall surface 62 and the second target wall surface 63, and is indicated by L2(L2x, L2y). The rotation angle φ31 is determined by the following formula. For simplicity, in FIG. 7, the robot emits the laser beam in the direction perpendicular to the first target wall surface 62 before rotation.

φ31=tan⁻¹((L1x−L2x)/(L1y−R1y))

The rotation angle 932 is the rotation angle when the laser point moves from L2 to M2 on the second target wall surface 63, and is determined by the following formula.

φ32=tan⁻¹((L2y−M1y)/(R1x−M1x))+tan⁻¹((M1y−M2y)/(R1x−M1x))

The rotation angle φ3 is determined by used of the obtained φ31 and φ32, as follows.

φ3=φ31+φ322

Alternatively the following formula may be used.

φ3=a tan 2(M2x−R2x,M2y−R2y)+π/2(rad)

Note that, in the above description, φ1=0. The function atan 2(x, y) is a function for determining an angle of counterclockwise rotation around the z-axis measured from the x-axis, and takes the value within ±π(rad). When φ1≠0, the angle φ1 is obtained first in the similar manner, and then the angle φ2 is obtained. The rotation angle φ3 is calculated by φ3=φ2−φ1. Thus, the rotation angle φ3 is obtained by use of the position R1(R1x, R1y) of the robot, the positions L1(L1x, L1y) and M2(M2x, M2y) of the laser points.

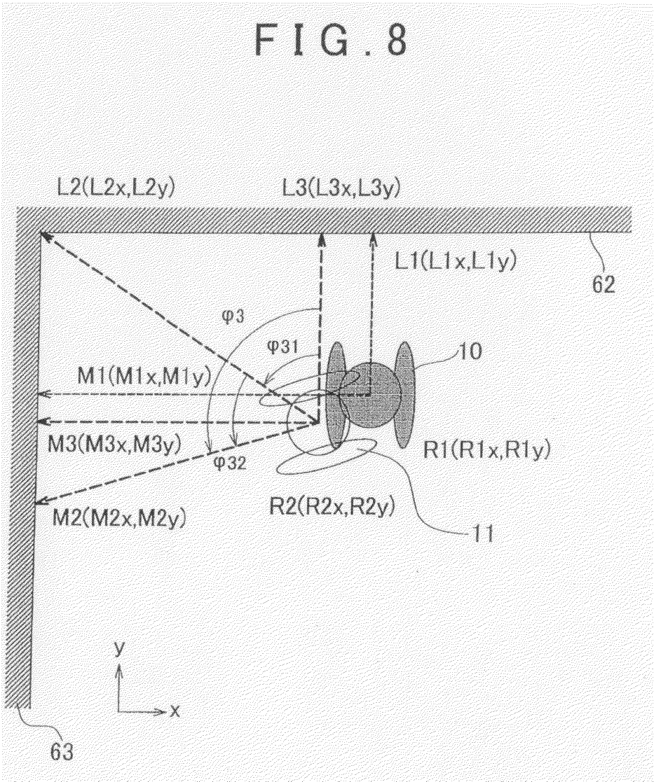

In the sixth example for determining the rotation angle φ3, the robot changes its horizontal position before and after the rotation in the fifth example. In other words, the position R1(R1x, R1y) of the robot 10 before rotation is different from the position R2(R2x, R2y) of the robot 11 after the rotation. The other conditions are the same as those in the fifth example. FIG. 8 is a view illustrating the sixth example. In FIG. 8, the positions of 13 and M3 are the positions of the two laser points respectively on the first and second target wall surfaces 62 and 63, when the robot 11 horizontally moves to the position R2(R2x, R2y), but has not yet rotate. In other words, the positions 13 and M3 are respectively the intersections of the target wall surfaces 62 and 63 and the perpendicular lines from the robot 11 to the target wall surfaces 62 and 63.

In this case, similar to the fifth example described with reference to FIG. 7, when the laser point remains in a single target wall surface before and after the rotation, the rotation angle φ3 is determined by the method for determining φ3 using only one target wall surface. On the other hand, when the rotation angle φ3 is large and the position of the laser point moves between two target wall surfaces, the rotation angle φ3 is determined by adding φ31 and φ32. The rotation angle φ31 is an angle while the laser point moves on the first target wall surface 62. The rotation angle φ32 is an angle while the laser point moves on the second target wall surface 63. Thus, the rotation angle φ3 is determined by the following formula.

φ3=φ31+φ32

When the robot emits laser beams to target wall surface 62 and the target wall surface 63, the position of the robot is obtained using the positions of the laser points. In other words, as shown in FIG. 7, when there are two target wall surfaces and two laser beams, and one laser beam is incident on the target wall surface 62 in the normal direction and the two laser beams are perpendicular to each other, the position R1(R1x, R1y) of the robot is determined by the following formula, using the positions L1(L1x, L1y) and M1(M1x, M1y) of the laser points,

R1x=L1x

R1y=M1y

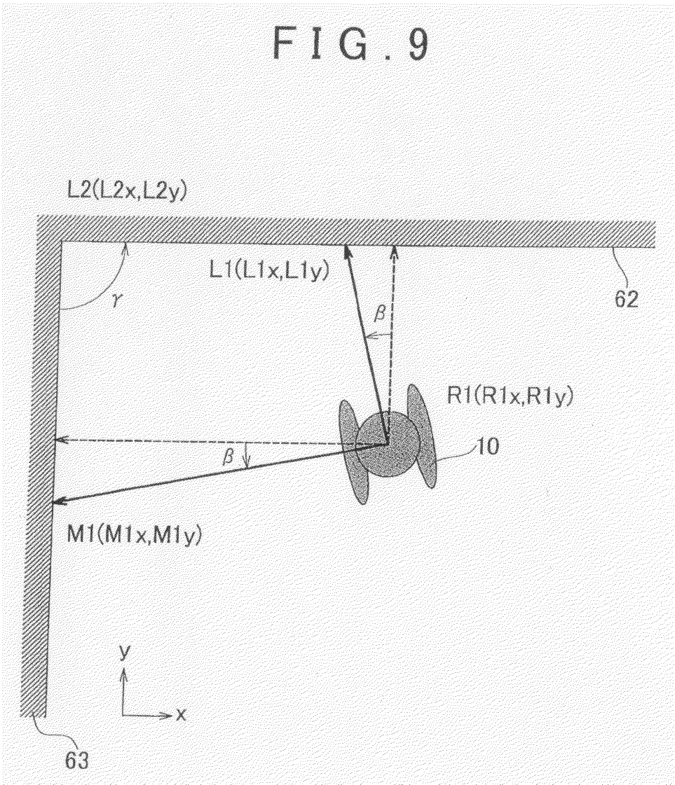

FIG. 9 is a view illustrating an example for determining the position of the robot under a more general condition. In this example, there are two target wall surfaces and two laser beams. One laser beam is incident upon the target wall surface 62 in an oblique direction and the two laser beams are perpendicular to each other. The incident angle β with respect to the target wall surface 62 is known in advance. As shown in FIG. 9, the incident angle β is measured from the perpendicular line to the target wall surface 62. In this case, the position R1(R1x, R1y) of the robot is determined by use of the positions of the two laser points and the incident angle β.

Assume that the angle γ between the two target wall surfaces is a right angle. The positions L1(L1x, L1y) and M1(M1x, M1y) are respectively the positions of the laser points on the target surfaces 62 and 63 illuminated with the laser beams from the robot 10. The position R1(R1x, R1y) of the robot is the intersection of the two straight lines represented by the following formulas.

y=M1y+sin β·x

x=L1x+sin β·y

In other words, x is calculated as follows:

x=L1x+sin β·(M2y+sin β·x)

x(1−sin²β)=L1x+sin β·M2y

x=(L1x+sin β·M2y)/(1−sin²β)

y is calculated as follows.

y=M2y+sin β·(L1x+sin β·y)

y(1−sin²β)=M2y+sin β·L1x

y=(M2y+sin β·L1x)/(1−sin²β)

The position R1(R1x, R1y) of the robot is determined by the following formula by use of x and y obtained above.

R1x=(L1x+M1y·sin β)(1−sin²β)

R1y=(M1y+L1x−sin β)/(1−sin²β)

When the angle γ between the two target wall surfaces is not right angle, similar to the fourth example explained with reference to FIG. 6, two virtual target wall surfaces are defined so that the angle γ therebetween is π/2(rad). The position R1(R1x, R1y) of the robot is determined as the intersection of the two straight lines, as described above.

As described above, in order to determine the rotation angle φ of the robot, the robot emits a laser beam to a target wall surface, and the positions of the laser point on the target wall surface(s) are measured. The rotation angle φ3 of the robot is determined using the changes in the position of the robot before and after the rotation.

Further, in addition to the measurement of the positions of the laser points, or instead of the measurement of the positions of the laser points, the distance from the robot to the target wall surface, or the moving distance of the robot may be measured and used.

As an alternative to the external camera as explained in FIG. 2, other detectors, such as a camera mounted on the robot may be used to measure the positions of the laser points on the target wall surface.

Further, in order to measure the positions of the laser points, a light reflected by the target wall surface may be detected or monito red. Alternatively, an optical position sensor may be used that produces luminescence and indicates the position of the illuminated point when the target wall surface is illuminated. With such an optical position sensor, the luminescence is detected to measure the positions of the laser points.

A length-measuring machine, such as a laser distance meter; may be used to measure the distance between the robot and the target wall surface.

To measure the moving distance of the robot, the rotation angle of the wheels of the robot may be measured. Alternatively, a marker may be provided on the floor or the wheels, and the movement of the marker may be measured. The marker on the floor may be a pattern of the floor. The position of the robot may also be measured by GPS.

If the calculation methods described above are appropriately combined, the rotation angle of the robot can be calculated more easily. For example, a first optical position sensor may be located on the target wall surface at a predetermined position relative to the positioning jig provided on the floor. The wheels of the robot may then be roughly aligned to the positioning jig. The robot emits a laser beam and detects that the laser beam is incident upon the exact position of the first optical position sensor. Then, the robot is fixed to the jig at the position and the reference position is thus determined. In this case, the position of the optical position sensor relative to the positioning jig on the floor may be determined in advance so that the laser beam is incident upon the target wall surface in the perpendicular direction.

Further, a second optical position sensor may be provided on the target wall surface at a predetermined position relative to the positioning jig and the first optical position sensor. Then, the robot is rotated to detect the position at which the laser beam is incident on the second optical position sensor. This position is defined as the initial position for calibration. In this case, the relative positions of the positioning jig on the floor, the first optical position sensor and the second optical position sensor are defined in advance so that the rotational angle φ3 is a predetermined angle, such as +30 degrees.

Thus, when the relative positions of the positioning jig on the floor, the first optical position sensor and the second optical position sensor are determined in advance, the distance from the robot to the optical position sensor, i.e., the distance from the robot to the laser point, is a preset value, and thus, does not need to be measured. According to the above setting, the markers on the wheels Or floor, such as the floor patterns, enables the detection of whether the robot horizontally moves before and after the rotation or of the amount of the movement of the robot. The preset distance values may be input through the input unit 84 of the remote controller 80, and the position calculator 82 may obtain the input distance values.

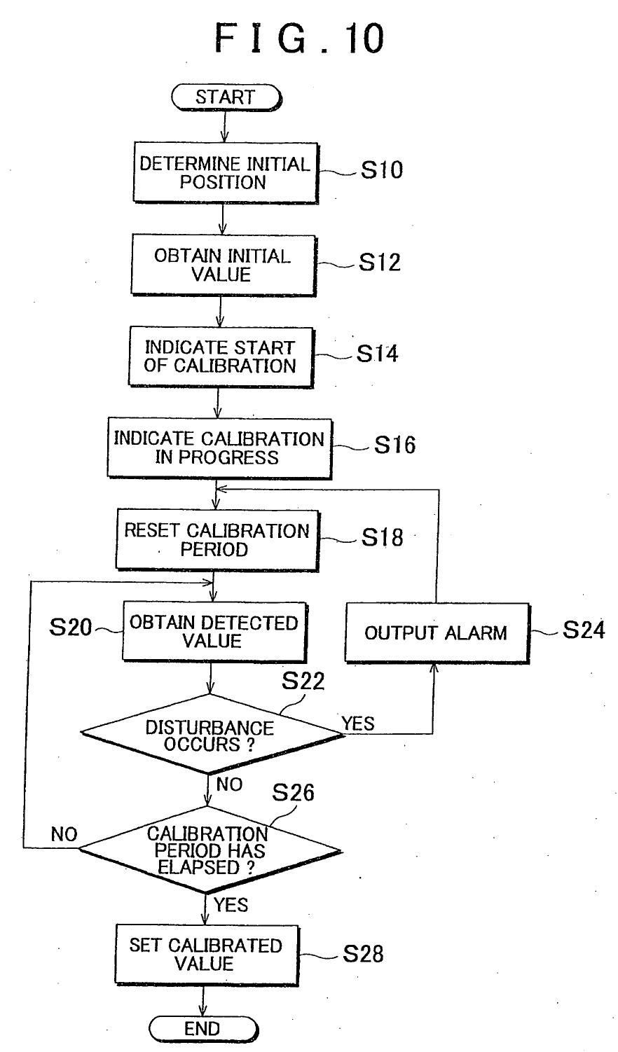

After the initial position of the robot 10 is measured and set, the optical gyro 18 is calibrated with respect to the initial position. The operation of the robot 10, in particular, each function of the calibrator 32 in the controller 30 is explained hereinafter with reference to the flowchart of FIG. 10. FIG. 10 is a flowchart illustrating the process for calibrating the optical gyro 18 of the robot 10. Each step in FIG. 10 corresponds to an operation of the calibration program. FIG. 10 shows the entire calibration process, including the process (S10), in which the position-measuring device 100 determines the initial position. The calibration of the optical gyro 18, which measures the position of the robot 10, is performed according to the process shown in FIG. 10. In the calibration, the robot 10 is fixed at a predetermined position and orientation, and multiple values measured by the optical gyro are obtained by consecutive sampling at the position condition. Because the position and orientation of the robot 10 are fixed, the values measured by the optical gyro are supposed to be a constant value. However, due to the high accuracy of the optical gyro 18, or the like, the measured values are sensitive to the disturbances. In other words, even slight shocks, impacts, etc., may cause the measured values to vary widely. Accordingly, the manufacturers of the optical gyros sometimes recommend taking a relatively long measuring time for calibration. The calibration period sometimes extends to several minutes. The optical gyro 18 must be prevented from being influenced by or interfered with such disturbances during the calibration. The calibration process is performed as follows.

At the start of the calibration process of the optical gyro 18 mounted on the robot 10, as shown in FIG. 10, the robot 10 is set at the initial position (S10). The initial position is a predetermined position set for the calibration. The optical gyro 18 detects an angular speed of the robot 10. The robot is fixed at a predetermined angle during the calibration, and the output_value of the optical gyro 18 at the predetermined angle is observed or monitored. Preferably, the output value at the predetermined angle is set to the calibrated value. By setting the calibrated value in this manner, the influence of the slight vibration caused by the driving unit 16, etc. of the robot is reduced or eliminated. As described above, because the optical gyro 18 detects angular speed around three axes, the angle is a three dimensional angle. However, only the calibration of the angle (F around the z-axis is described hereinafter.

The process (S10) that determines the initial position, including a process that sets the robot 10 at the reference position performed by the position-measuring device 100, and a process that rotates the robot 10 from the reference position and determines the rotation angle φ. The detailed description of this process will be omitted. After the predetermined rotation, the robot 10 is fixed to the floor surface by attaching wheel stoppers to the wheels 12 to prevent its horizontal movement. In addition, the controller 30 instructs the driving unit 16 to remain in stationary state, and thus the entire mechanical actions of the wheel for (horizontal) movement stop.

When the initial position of the robot 10 is established, then an initial value is obtained (S12). In more detail, the rotation angle φ (corresponding to φ3 in the above description, but indicated by (hereinafter), which is obtained by the position-measuring device 100 in the manner as described above and is an initial value corresponding to the established initial position, is input to controller 30 by the input unit 84. The calibrator 32 obtains the rotation angle φ by use of the initial-value obtaining module 40. The controller 30 may use a wired or wireless communication to receive data, such as the initial value, from the input unit 84. In this embodiment, φ=+30 degrees is input (by the input unit 84) and obtained (by the calibrator 32) as the initial value of the position (information) of the robot 10 that is set at the initial position.

Then, the calibrator 32 indicates a start of calibration (S14) and a calibration in progress (S16), by use of the status output module 48. The steps (S14 and S16) indicate (display) the status (stages) of the calibration, such as a start of calibration or calibration currently in progress, to the exterior. The objective of these steps is to inform bystanders (people around the robot 10) of the stages of the calibration and to encourage them to pay attention to the robot 10. According to the indication, disturbances caused by the bystanders may be suppressed during the calibration. In more detail, the calibrator 32 may indicate the start of the calibration on the indicator 20 with light or sound, and may display the estimated remaining time to the end of calibration or the status (stage) of calibration to indicate the calibration progress. For example, a green light may be turned on or made to blink on and off to indicate the start of the calibration, and the remaining time to the end of calibration is displayed in seconds to indicate the calibration progress.

Next, the calibration period timer is reset (S18). In other words, a timekeeping process of the calibration period is started. In more detail, a calibration period timer, in which a predetermined total calibration period is set to an initial time, and the remaining time decreases as the calibration proceeds, may be used. When a new calibration starts, the initial time is reset to the predetermined total calibration period. For example, when the total calibration period is five (5) minutes (=three hundred (300) seconds), the initial time is set to 300 seconds and a timer, in which the remaining time decreases as the calibration proceeds, is used. At the time of each start of a new calibration, the initial time is reset to 300 seconds. Thus, the reset of the initial time indicates a start of each timekeeping process of the calibration period. The total calibration period may be determined based on the purpose of the robot 10, required accuracy/precision of the position information, and the sensitivity of the optical gyro 18.

Then, the values detected by the optical gyro 18 are obtained as data for the calibration (S20). In this step, the calibrator 32 obtains the values detected by the optical gyro 18 in every sampling period, by use of the detected-value obtaining module 42. The sampling period may be ten (10) msec. In this embodiment 30,000 (−100*300) detected values, in total, are obtained during the entire calibration period.

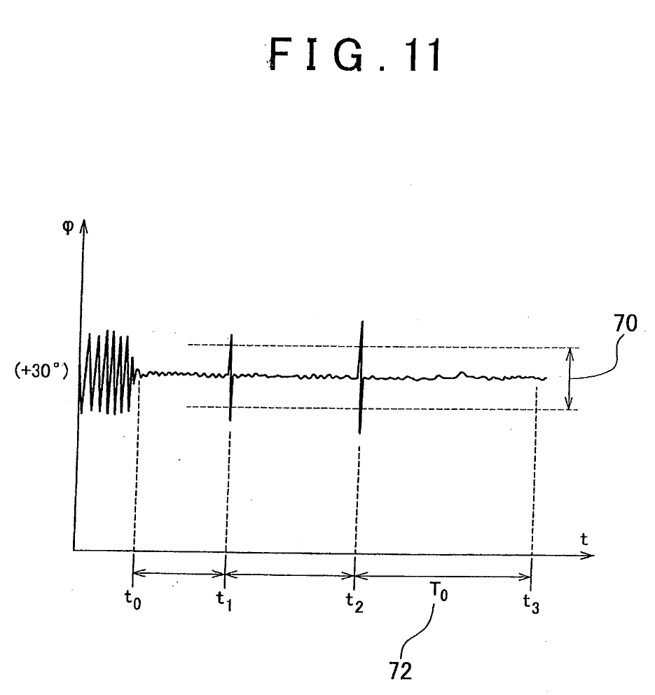

While the calibrator 32 obtains the values detected by the optical gyro 18, the calibration period timer decreases the remaining time as time passes. Further, during the period, it is determined whether any disturbances have occurred (S22). The occurrence of any disturbances may be determined by checking whether any of the values detected by the optical gyro 18 is abnormally high. FIG. 11 shows an example of such a situation. In FIG. 11, the horizontal axis represents time, and the vertical axis represents the rotation angle φ around the z-axis. The rotation angle φ is calculated from the output of the optical gyro 18. At the time t0, the robot 10 is set and fixed to the +30-degree initial position, in S10. The fluctuation in φbefore the time to indicates noises before the position is fixed. After the time t0, the rotation angle φis generally constant. However, abnormal values are detected at the time t1 and t2. In other words, disturbances make noises that occur at the time t1 and t2. As shown in FIG. 11, the occurrence of noises may be determined by checking whether the rotation angle q exceeds an appropriately predetermined threshold range 70. The threshold range may be determined based on the accuracy/precision required in the calculation of the position of the robot 10 or the accuracy/precision required in the calibration. The threshold range may be set to ±2 degrees, for example.

When it is determined that any disturbances have occurred, the calibrator 32 outputs an alarm signal by use of the alarm module 50 (S24), and the controller 30 indicates the occurrence of the disturbances on the indicator 20. For example, a red light may be turned on or made to blink on and off, or a buzzer may sound or a voice alert may be given. The alarm notifies bystanders (people around the robot) that a disturbance has been detected and warns them not to cause any further disturbances.

In addition, when it is determined that a disturbance has occurred, the instruction module 44 of the calibrator 32 provides an instruction for recalibration. Accordingly, the process returns to S18, and the calibration period timer is reset. The values detected by the optical gyro 18 by then are discarded, and the calibrator 32 restarts, from the beginning, the process to obtain the values detected by the optical gyro 18. Then, it is determined whether the calibration period elapses (S26). In more detail, it is determined whether the remaining time of the calibration period timer reaches zero. If the calibration period has not elapsed, the process returns to S20, and the calibrator 32 continues to obtain the values detected by the optical gyro 18 until the calibration period elapses.

FIG. 11 illustrates such a situation. In other words, in FIG. 11, the calibration period is set to T0. At time t1, by which the calibration period T0 has not elapsed from the time t0, a noise that exceeds the threshold range 70 is detected. Thus, it is determined that a disturbance has occurred. Then, the recalibration is determined and the calibration period timer is reset at the time t1. Next, at the time t2, by which the calibration period T0 has not elapsed from the time t1, a noise that exceeds the threshold range 70 is detected again. Therefore, the recalculation is again determined at the time t2. Then, no disturbance, which exceeds the threshold range 70, occurs from the time t2 to the time t3, at which the calibration period (T0) elapses. Accordingly, at the time t3, the calibrator 32 obtains, for the first time, the complete values detected by the optical gyro 18 for the entire calibration period T0 without any disturbance.

If it is determined that the calibration period elapses, a calibrated value is determined based on the detected values that are sampled during the calibration period (S28). In more detail, the calibrator 32 performs statistical processing of the all detected values by the calibrated-value setting module 46. For example, an average of the 30,000 detected values may be calculated. The statistical processing may include a process that sets a second threshold range smaller than the threshold range 70 and calculates the average of the detected values within the second threshold range, an appropriate weighting process, a process coupled with a standard deviation, and so on, as well as the simple averaging process. For example, in the example shown in FIG. 11, if the average of the 30,000 detected values is +29.5 degrees, then this is the calibrated value for the initial value +30 degrees.

After the calibrated value is determined for the established initial position as described above, the calibration process terminates. In the above description, only the configuration that calibrates the rotation angle φis explained. A similar calibration is then performed with respect to the rotation angles θ and ψ at the same time or thereafter. After the calibration for the three axes of the optical gyro 18 is completed, the indicator 20 indicates the completion of calibration and the wheel stoppers may be removed. Then, the values detected by the optical gyro 18 are calibrated using the calibrated value thereafter. The position information calculator 34 calculates the position information of the robot 10 based on the calibrated values. Then, the controller 30 outputs, to the driving controller 36 the instructions necessary for an entertainment action based on the calculated position information of the robot 10 and an entertainment program. As described above, the robot 10 can perform these actions with high accuracy.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

1-19. (canceled)

20-38. (canceled)

39. A gyro calibration apparatus that calibrates a gyro for detecting position information mounted on a mobile object, the gyro calibration apparatus comprising:
a beam emitter that emits a beam of light;
a beam position detector that detects a position illuminated by the emitted beam of light;
a calculator that calculates at least one of a position and an orientation of the mobile object in accordance with the illuminated position detected by the beam position detector; and
a calibrator that calibrates the gyro in accordance with the at least one of the position and the orientation of the mobile object calculated by the calculator.

40. The gyro calibration apparatus according to claim 39, wherein the beam position detector comprises a measuring section that measures a distance from the mobile object to the illuminated position, and wherein
the calculator calculates at least one of the position and the orientation of the mobile object in accordance with the distance from the mobile object to the illuminated position, in addition to the illuminated position.

41. The gyro calibration apparatus according to claim 39, wherein the beam position detector comprises a measuring section that measures a moving distance of the mobile object while the mobile object rotates, and wherein
the calculator calculates at least one of the position and the orientation of the mobile object in accordance with the moving distance of the mobile object, in addition to the illuminated position.

42. The gyro calibration apparatus according to claim 39, wherein the beam emitter emits the beam of light in a plurality of directions.

43. The gyro calibration apparatus according to claim 39, wherein the beam positioning detector is a position-measuring device mounted on the mobile object.

44. The gyro calibration apparatus according to claim 39, wherein the beam position detector is an external position-measuring device provided separately from the mobile object.

45. A gyro calibration apparatus that calibrates a gyro for detecting at least one of an angle or an angular speed mounted on a mobile object, the gyro calibration apparatus comprising:
a beam emitter that emits a beam of light that illuminates an immobile object, wherein the beam emitter is provided on the mobile object;
a beam position detector that detects a first position illuminated on the immobile object by the emitted beam of light when the mobile object is at a reference position, and for detecting a second position on the immobile object illuminated by the emitted beam of light after the mobile object is rotated from the reference position to an initial position;
a calculator that calculates a rotation angle of the mobile object in accordance with the first position and the second position detected by the beam position detector; and
a calibrator that calibrates the gyro in accordance with the rotation angle of the mobile object calculated by the calculator.

46. The gyro calibration apparatus according to claim 45, wherein the calibrator comprises:
an initial-value obtaining section that obtains the rotational angle as an initial position value;
a detected-value obtaining section that obtains a plurality of values detected by the gyro for a predetermined period while the mobile object remains in the initial position;
an instruction section that instructs the detected-value obtaining section to restart obtaining a plurality of values if a disturbance is detected; and
a calibrated-value setting section that determines a calibrated position value based on the plurality of values obtained by the detected-value obtaining section, and that sets the calibrated position value to a calibrated value for the initial position value.

47. The gyro calibration apparatus according to claim 46, wherein the calibrated-value setting section calculates an average of the plurality of values obtained by the detected-value obtaining section and sets the average to the calibrated value.

48. The gyro calibration apparatus according to claim 46, further comprising a status output section that outputs a signal indicating that a calibration is in progress.

49. The gyro calibration apparatus according to claim 46, further comprising an alarm that outputs an alarm signal indicating occurrence of the disturbance.

50. A program that is performed by a calibrator that calibrates a gyro for detecting position information mounted on a robot, the program comprising the steps of:
calculating a rotation angle of the mobile object in accordance with a first position that is detected on an immobile object illuminated by an emitted beam of light when the mobile object is at a reference position, and a second position that is detected on the immobile object illuminated by the emitted beam of light after the mobile object is rotated from the reference position to an initial position; and
calibrating the gyro in accordance with the rotation angle of the mobile object;
the calibration including:
obtaining a rotation angle as an initial position value;
obtaining a plurality of values detected by the gyro for a predetermined period while the robot remains in the initial position;
providing an instruction to restart the obtaining of the plurality of values when a disturbance is detected;
determining a calibrated position value based on the obtained plurality of values; and
setting the calibrated position value to a calibrated value for the initial position value.

51. A method for calibrating a gyro for detecting position information mounted on a mobile object, the method comprising:
emitting a beam of light;
detecting a position illuminated by the emitted beam of light;
calculating at least one of a position and an orientation of the mobile object in accordance with the detected illuminated position; and
calibrating the gyro in accordance with the calculated at least one of the position and the orientation of the mobile object.

52. A method for calibrating a gyro for detecting at least one of an angle and an angular speed mounted on a mobile object, comprising:
emitting from the mobile object a beam of light that illuminates an immobile object;
detecting a first position on the immobile object illuminated by the emitted beam of light when the mobile object is at a reference position, and detecting a second position on the immobile object illuminated by the emitted beam of light after the mobile object is rotated from the reference position to an initial position;
calculating a rotation angle of the mobile object in accordance with the detected first position and the detected second position; and
calibrating the gyro in accordance with the rotation angle of the mobile object.

53. The method for calibrating a gyro according to claim 52, further comprising:
obtaining the rotation angle as an initial position value;
obtaining a plurality of values detected by the gyro for a predetermined period while the robot remains in the initial position;
providing an instruction to restart the obtaining of the plurality of values when a disturbance is detected;
determining a calibrated position value based on the obtained plurality of values; and
setting the calibrated position value to a calibrated value for the initial position value.

54. A robot, comprising:
a gyro that detects a position of the robot; and
a gyro calibration apparatus that calibrates the gyro,
the gyro calibration apparatus comprising:
a beam emitter that emits a beam of light that illuminates an immobile object, the beam emitter being provided on the mobile object;
a beam position detector that detects a first position on the immobile object illuminated by the emitted beam of light when the mobile object is at a reference position, and that detects a second position on the immobile object illuminated by the emitted beam of light after the mobile object is rotated from the reference position to an initial position;
a calculator that calculates a rotation angle of the mobile object in accordance with the first position and the second position detected by the beam position detector; and
a calibrator that calibrates the gyro in accordance with the rotation angle of the mobile object calculated by the calculator; wherein
the calibrator comprises
an initial-value obtaining section that obtains the rotation angle as an initial position value;
a detected-value obtaining section that obtains a plurality of values detected by the gyro for a predetermined period while the robot remains in the initial position;
an instruction section that instructs the detected-value obtaining section to restart obtaining a plurality of values if a disturbance is detected; and
a calibrated-value setting section that generates a calibrated position value based on the plurality of values obtained by the detected-value obtaining section, and sets the calibrated position value to a calibrated value for the initial position value.
